(19) United States
(12) Patent Application Publication
(10) Pub. No.: US 2023/0056717 A1
(43) Pub. Date: Feb. 23, 2023

(54) Fluid Containment Covering for Pipe Leaks

(71) Applicants: Eric Benson, Poway, CA (US); Trevor Terra, Poway, CA (US)

(72) Inventors: Eric Benson, Poway, CA (US); Trevor Terra, Poway, CA (US)

(21) Appl. No.: 17/780,463

(22) PCT Filed: Jan. 21, 2021
(86) PCT No.: PCT/IB2021/000541

§ 371 Date: May 26, 2022

Related U.S. Application Data
(60) Provisional application No. 62/964,027, filed on Jan. 21, 2020.

(51) Int. Cl. F16L 55/17; G01N 21/78

(52) U.S. Cl. CPC F16L 55/17; G01N 21/78

(57) ABSTRACT

A flexible fluid containment covering is provided which is configured for temporary engagement over a leak in a pipe carrying fluid. A flexible body of the covering is positionable upon a leaking pipe to channel leaking fluid downward through an exit from a gap formed between a first half portion and second half portion of the body. Channels may be positioned on the contact side of the body to direct fluid downward. When placed upon a leaking pipe, the covering prevents fluid from spraying upward and outward and allows for container collection of the fluid.

### FIELD OF THE INVENTION

This application claims priority to U.S. Provisional patent application Ser. No. 62/964,027, filed on Jan. 21, 2020, which is incorporated herein in its entirety by this reference thereto.

The present device relates to pipe leakage of liquids flowing therethrough such as hydrocarbon fuels, chemicals and other flammable and hazardous liquids. More particularly, the device herein relates to a covering configured to engage over a pipe which is leaking hazardous liquid such as highly flammable fuels, and to contain spray and atomized fuel and the like thereunder until the pipeline is depressurized.

### BACKGROUND OF THE INVENTION

In the marine industry and military, ocean going ships suffer from ongoing hazards due to the proximity of high pressure hydrocarbon and fuel lines which are located in the engine room and other compartments. Because such ships are surrounded by water, crew and operators thereof may believe fire is low on the list of potential hazards.

However, large commercial and military vessels are in fact highly susceptible to fire which can severely damage and even sink the vessel. This is primarily due to the heavy machinery and equipment found in engine rooms, boiler rooms, and adjacent areas, most of which are located below the water line of the ocean or other waterway in which the ship is navigating.

In general, every fire, in order to ignite and remain burning, requires air, fuel and a heat source to ignite and maintain the flames. In the case of commercial and military ships, they have all three of these fire ingredients in abundance in the engine and boiler rooms and sections with heavy machinery.

In the case of engine or boiler rooms, highly flammable fuel and gases are present within adjacent pipes which are conventionally under high pressure. Leaky high-pressure pipes can emit fuel in an explosive form as highly atomized particles, or can cause highly flammable puddles of fuel or oil to form on the deck. It is, thus, imperative that leaks in pipelines carrying such fuel and gases be contained quickly.

While not as severe a risk as a fire at sea, industrial facilities such as refineries and chemical plants also employ pressurized pipes carrying flammable and caustic fluids. They, thus, have the same risks of fire and contamination when a leak of fluid from a pressurized pipe occurs.

The containment covering herein provides an easily used component adapted to cover liquid leaks in pipes, which can be stowed in a compact form in areas prone to such leaks. Areas where it may be easily retrieved and deployed to significantly reduce the potential for fire and contamination in areas adjacent such a leak whether in an engine room of a marine vessel or at a chemical plant or refinery.

The forgoing description and exemplars concerning fluid leaks on marine vessels and the dangers posed thereby due to the inadequate state of the art, is intended to be illustrative and not exclusive. As such, no limitations on the invention described and claimed herein is to be associated with such. Further, additional limitations of the related art for fluid leak containment in a marine and industrial environment are well known, or such will become apparent to those skilled in the art upon a reading and understanding of the specification below and the accompanying drawings.

### SUMMARY OF THE INVENTION

The fluid leak containment system disclosed herein, provides an easily employed remedy to the serious problem of leaking pipes on marine vessels and the like. Through the provision of a flexible containment cover, which is easily folded and stored in areas proximate to potential fluid leaks, the disclosed device can significantly reduce the risk of fire or marine vessels through the ability to quickly deploy the containment covering in an emergency situation.

The fluid leak containment device herein, has a body which is flexible and easily removed from compact storage and deployed to cover fluid leaks from pipes which, as noted, can be especially dangerous where such pipes carry flammable liquids or hazardous chemicals. The body has an exterior layer on both opposing side surfaces which is formed of material which is preferably heat resistant and resistant to deformation from contact with hydrocarbon liquids such as engine fuel.

Because the planar body of the device is relatively thin, it may be folded to a compact configuration and stored in a housing or emergency container which is positioned adjacent to pressurized pipes having the potential for leaks, whereby it may be quickly found and deployed to cover the leak. Opposing edges of the planar flexible body of the device are preferably weighted along both edges with flexible weight components such as glass beads which will not easily melt when exposed to heat, or metal chain which is flexible and also resists melting.

In use, personnel responding to a leaking pipe, can retrieve the stored device and transport it to the site of the leak. Thereafter, the unfolded body may be positioned over the leak in the pipe with a central section of the body in contact with the pipe and two side surfaces hanging on opposing sides of the pipe. So positioned, the weighted edges on the opposing sides will hold the body in position and enable the device to direct the flow of leaking liquid downward toward the weighted edges. Additionally, provided are removably engageable fasteners such as snaps, buttons, or hook and loop fabric, or other cooperative fasteners to allow the user to secure the two side portions together to provide a secured engagement over a pipe.

With respect to the above description, before explaining at least one preferred embodiment of the herein disclosed pipe engageable liquid containment device in detail, it is to be understood that the invention is not limited in its application to the details of construction and to the arrangement of the components in the following description or illustrated in the drawings. The pipe engageable invention herein described and shown is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other flexible liquid containment devices for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The term “substantially” when employed herein, means plus or minus twenty percent unless otherwise designated in range.

It is an object of the present invention to provide an easily stowed blanket or fluid containment covering, which is configured for an easy and self-maintaining positioning over a leak in a pipe, to thereby direct leaking liquid therefrom away from machinery and equipment which may ignite it.

It is a further object of this invention to provide such a containment covering which will direct leaking fluid toward room surfaces where it may be pumped or contained for removal safely.

These and other objects, features, and advantages of the present flexible weighted pipe leak containment device, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed pipe engageable liquid containment device. It is intended that the embodiments and figures disclosed herein are to be considered illustrative of the invention herein, rather than limiting in any fashion.

In the drawings:

FIG. 1 is an overhead plan view of the device, showing the flexible planar body formed of material resistant to fuel and chemicals and showing pockets engaged on opposing side edges holding glass beads or other components adapted to impart force from weight thereof to one side of the body when engaged over a leaking pipe along with separable fasteners which are employable to connect the two side portions if needed.

FIG. 2 shows a mode of the device of FIG. 1 in an as-used positioning draped over a leaking pipe and containing fuel or liquid leaks by directing the flow downward toward the weighted sides.

FIG. 3 shows a perspective view of the device as in FIG. 1 showing cavities engaged to the opposing side edges which form flexible weights for both sides of a pipe-engaged body of the device.

FIG. 4 is a sectional view along the lines 4-4 in FIG. 3, showing the cavity either formed of fabric or otherwise engaged to the opposing edges of the body of the device.

FIG. 5 shows the device as in FIG. 1, with projections on the contacting side of the body which engages over the pipe, where the projections are positioned to funnel leaking fluid toward a central area of the draped device.

FIG. 6 shows another mode of the device as in FIG. 1, wherein a plurality of projections extend from the contacting side of the body of the device and direct fluid flow down channels therebetween.

FIG. 7 depicts a chemically reactive patch which may be included in all modes of the device, which reacts to fluid contact and changes appearance where the fluid is hydrocarbon fuel or other substances to which the patch is adapted to react.

FIG. 8 depicts the device herein showing the body from the exterior surface side and showing a plurality of flexible securement members positioned to extend from both the first side edge and second side edge.

FIG. 9 shows the device as in FIG. 8, and depicts the flexible securement members engaged to the exterior surface in a stowed positioning.

FIG. 10 shows the device as in FIGS. 8-9, where the body is positioned to an engaged position encircling a pipe with half portions of the contact surface facing each other and channeling fluid flow downward.

FIG. 11 is a side view of the device shown in FIG. 10 showing the body in the engaged position around the exterior of a pipe and the flexible securement members engaged.

FIG. 12 depicts the device herein wherein a heat and fluid resistant surface is positioned upon the contact surface of the body.

FIG. 13 shows the device as in FIG. 12 in an engaged position upon a pipe to channel fluid from the pipe downward in-between facing half portions of the contact surface which has the heat and fluid resistant surface thereon.

FIG. 14 depicts an especially preferred mode of the device as in FIGS. 12-13, wherein linear channels are formed into the heat and fluid resistant surface area and run along a line extending toward the first end and second end of the body to form fluid channels to better capture and channel fluid from a pipe.

### DETAILED DESCRIPTION OF THE INVENTION

In this description, the directional prepositions of up, upwardly, down, downwardly, front, back, top, upper, bottom, lower, left, right, front, back, and other such terms refer to the device as it is oriented and appears in the drawings and are used for convenience only and such are not intended to be limiting in any fashion, or to imply that the device has to be used or positioned in any particular orientation.

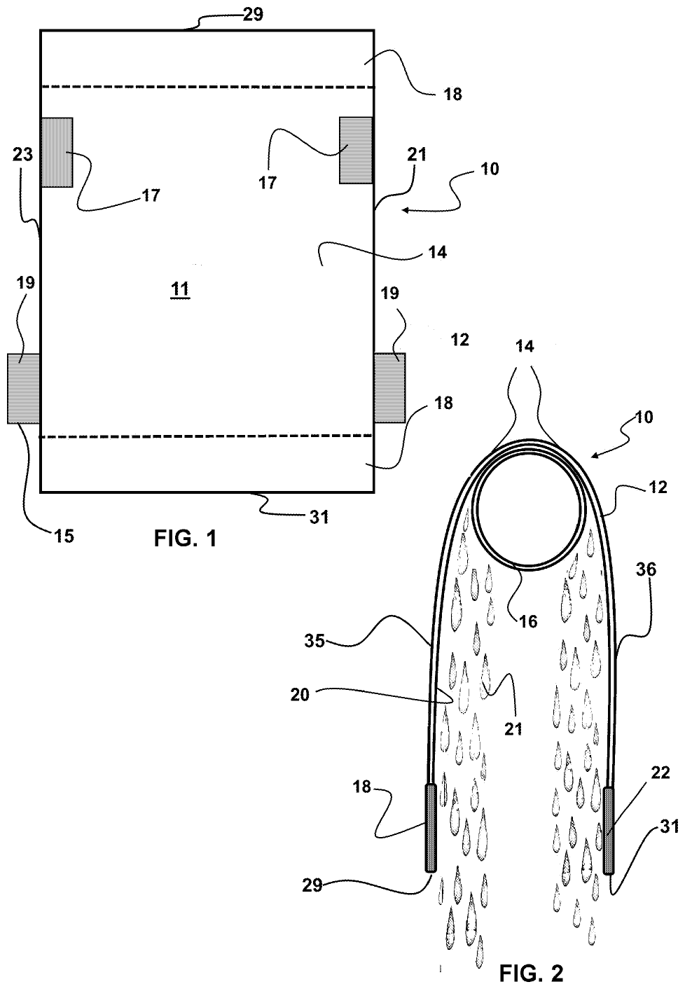

Now referring to drawings in FIGS. 1-14, wherein similar components are identified by like reference numerals, there is seen in FIG. 1, the device 10 in one preferred mode showing the flexible planar body 12 from a first or exterior surface 11. The body 12 is preferably formed of material which is resistant to fuel and chemicals and the like and is heat resistant, such as NOMEX, neoprene coated over a reinforced scrim, silicone coated fiberglass, aluminum mesh, metal mesh, fiberglass, woven silica, or vermiculite, or other woven or non woven fabrics and materials as would occur to those skilled in the art, or combinations thereof.

Such fabrics forming the body 12 may be sewn, or heat sealed, or engaged with RF or adhesive to form the body and components herein which may be engaged thereto. Additionally shown and employable in all modes of the device 10 herein, are securement members 15 which may extend from their engagements at first ends thereof to the body 12. The securement members 15 in the preferred mode of the device 10 extend from a first side edge 21 and a second side edge 23 of the body 12 and have separable fasteners 17 and 19 positioned thereon.

The separable fasteners 17 and 19, forming or positioned on the flexible securement members 15, such as hook and loop fabric, snaps, buttons, hooks, magnets, or other separable fasteners as may occur to those skilled in the art, are employable to hold the body 12 mounted with half sections hanging from a pipe 16, and thereby augment the weighted ends 22 to maintain the body 12 of the device 10 in the engaged position as in FIG. 2.

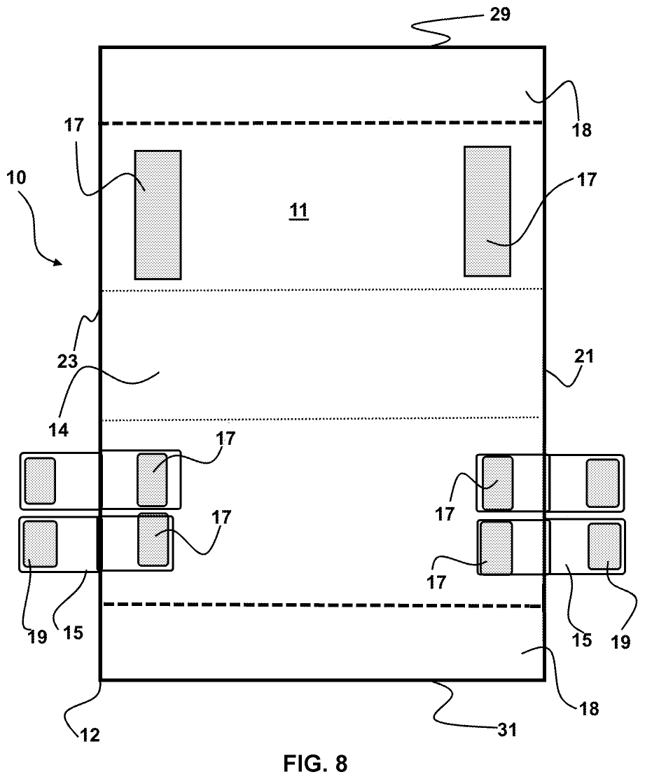

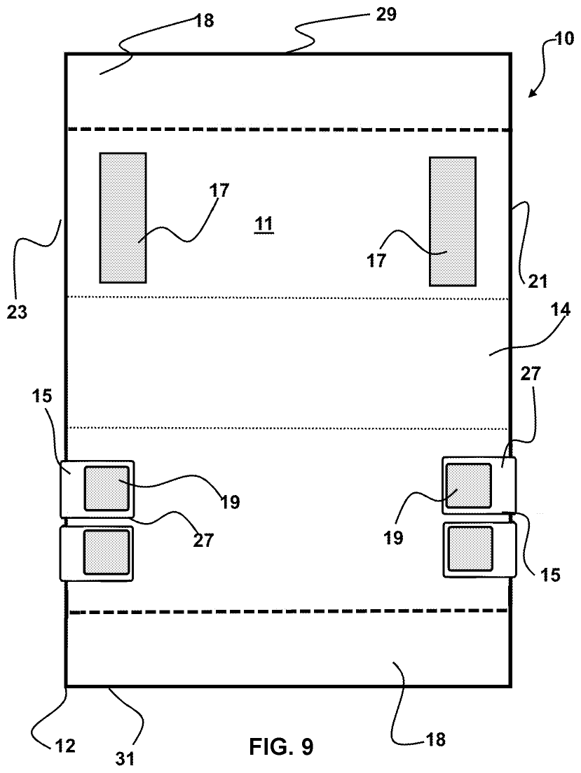

It should be noted, where the separable fasteners 17 and 19 are configured from flexible hook and loop style fabric, such as in FIG. 1, the hook and loop fabric itself may form the securement members 15. In particularly preferred modes of the device 10 herein, the securement fasteners 17 and 19, are engaged upon one or both side surfaces of the flexible securement members 15 such as shown in FIGS. 8-14. This configuration, in experimentation, has shown to provide for better storage of the device 10 to keep the securement members 15 more compact and to allow storage of the device 10 held in a folded position by engaged securement members 15. Such is shown in, for example, FIG. 9.

A central section 14 of the body 12, located between the first end 29 and second end 31, is configured for draping contact with a pipe 16 (FIG. 2) when the device 10 is operatively positioned to an engaged position. Such an engaged position, for example, is shown in FIG. 2 and FIG. 11.

On or adjacent opposing ends 29 and 31 of the body 12 are positioned weight components. By weight components is meant for example, metal members, chains, clips, beads, sand, or other weight imparting components. Currently, weight components are preferably provided by weighted cavities 18, which are sealed to hold flexible weights therein. Currently, glass beads are employed to fill the two cavities 18 as flexible weights, and provide the mass to impart force from gravity to opposing ends 29 and 31 of the body 12 on each side of the central section 14, when in an engaged position on a pipe 16 such as in FIGS. 2 and 11. Such is preferred in order to hold the body 12 in the engaged position upon a pipe 16 which may have liquid leaking therefrom under pressure which would dismount the body 12 if not weighted on both ends.

In all modes of the device 10 herein, the body 12 is configured for a draped, weighted, engagement, to the engaged or an as-used positioning. In this engaged or as-used position, the body 12 is draped over a leaking pipe 16, with half portions hanging from both sides of the pipe 16. Experimentation has shown that such positioning prevents water or atomized fuel or other liquids from spraying in multiple directions. Such has shown in experimentation to prevent leaking fuel in atomized or liquid form, from traveling to other areas of a room distant from the leak in the pipe 16.

As shown in FIG. 2, with the device 10 having the body 12 draped over a pipe 16 in an as-used positioning, the central section 14 on the first or contact side surface 20 of the planar flexible body 12 will contact against the exterior of a pipe 16. The flexible weights 22 held in the sealed cavities 18, such as glass or metal beads or metal chain, or other weights which will flex and resist heat, provide mass whereby gravity pulls on opposing half portions of the body 12, when engaged over the pipe 16. Fluid 21 leaking from the pipe 16 is prevented from dismounting the body 12 and from spraying in multiple directions and is directed downward between the two hanging half sections of the body 12 of the device 10.

The sealed cavities 18 for holding weights therein, can be formed by folding over the fabric forming the body 12 at both opposing side edges and sewing or otherwise attaching the folded portions. The sealed cavities 18 may also be formed as a separate component and attached along both of the opposing first end 29 and second end 31 of the body 12 of the device 10 such as with adhesive, sewing, or fasteners such as grommets or snaps or other mating fasteners. In order to stow the device 10 easily in a compact configuration, the weights within the sealed cavities 18 are preferably flexible or pliable.

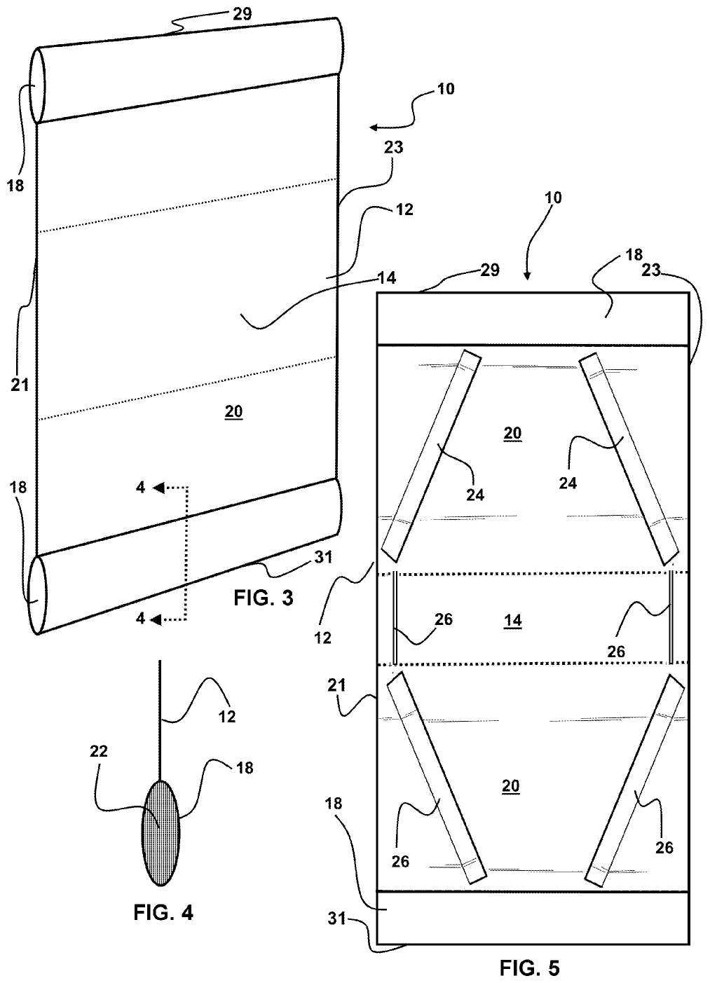

In FIG. 3 is shown a perspective view of the device 10 as in FIG. 1. As shown, the contact side surface 20 of the body 12 is configured to wrap upon and contact against the exterior surface of a leaking pipe 16. To that end, the central section 14 on the contact side surface 20, positioned between the first end 29 and second end 31, and running between the first side edge 21 and second side edge 23, may be formed of multiple layers of materials or otherwise reinforced if such is needed.

Also shown in FIG. 3, are the sealed cavities 18 at or adjacent the first end 29 and second end 31 of the body 12. As noted, the cavities 18 are sealed to hold the pliable or flexible weight material therein. The sectional view in FIG. 4 is taken along line 4-4 of FIG. 3. As shown in FIG. 4, the flexible weight 22 such as metal or glass beads or chain or sand or the like, is in sealed engagement within the formed cavity 18 engaged to or adjacent the first end 29 and second end 31 of the body 12.

Shown in FIG. 5 is another preferred mode of the device 10 wherein the contact side surface 20 of the body 12 includes a channeling component. By the term channeling component is meant that structures are positioned on the contact side surface 20 to capture and redirect fluid downward in between the half sections of the body 12 in the engaged positions of FIGS. 2 and 11. Such aids in preventing fluid from projecting from in between the two half sections of the draped body and escaping from the first side edge 21 and second side edge 23 with the device in the as-used position. Such channeling minimizes the area of fluid contact with the area surrounding the body 12 by directing it toward the floor.

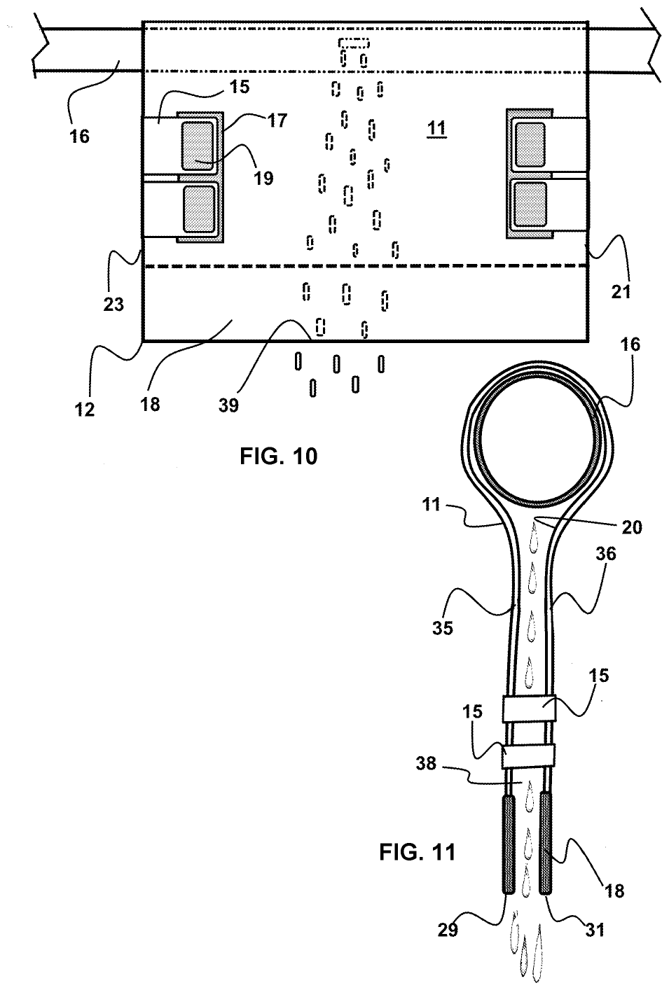

As shown in FIG. 5, the channeling component may be provided by channeling members 24 which project from the contact side surface 20. The channeling members 24 may be formed of the same material as the body 12 by seaming it, or may be formed in fabric, polymeric, or neoprene strips that are adhered to the contact side surface 20. As shown in FIG. 5, the channeling members 24 run at an angle toward the center of the first end 29 and adjacent second end 31 of the body 12 and are adapted to channel flowing fluid toward the center area of the body 12 when hanging such as shown in FIG. 10.

Also shown in FIG. 5 are flexible sealing members 26 which may be included in all modes of the device 10 herein. Such sealing members 26 run along a line substantially parallel to the first side edge 21 and second side edge 23. In this fashion they may be positioned to traverse across the central section 14 of the body 12 and be positioned to contact against top and side surfaces of the pipe 16 with the device 10 in the engaged or as-used position of FIG. 2.

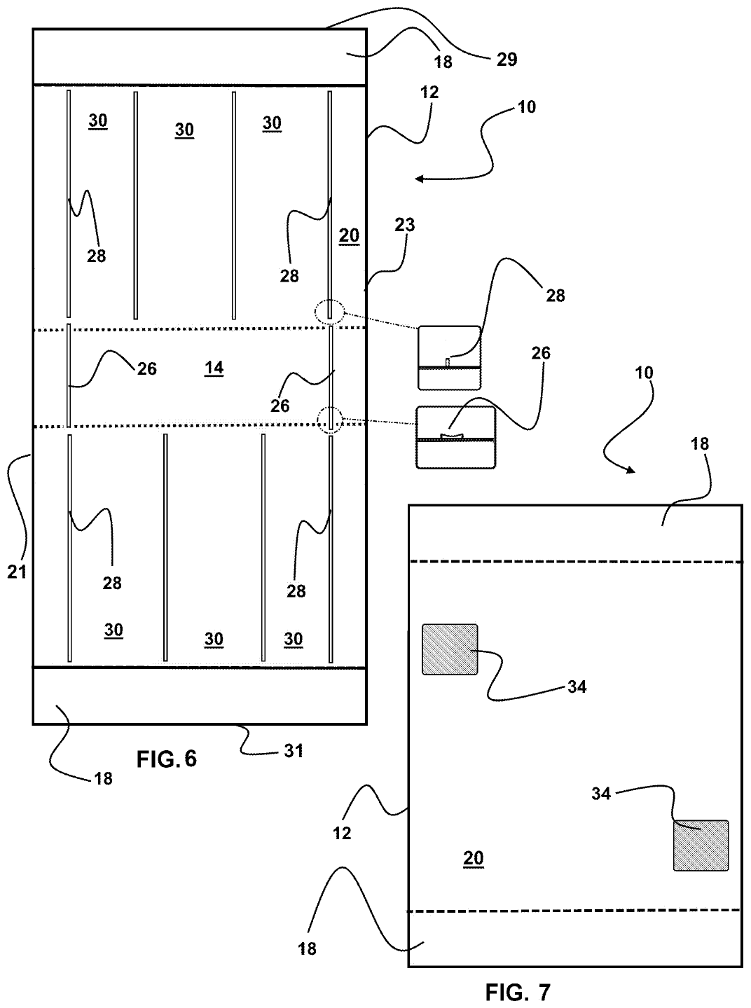

Because fluid tends to be cohesive and stick to and flow upon solid surfaces such as a pipe exterior, the sealing members 26 can be provided to help stop fluid flow along the top and side surfaces of a leaking pipe 16, out of the confines of the engaged device 10. The sealing member 26 is shown in enlarged depictions in FIG. 6 to have a curved pipe contacting surface which will contact and adhere against the exterior pipe surface when the device 10 is engaged thereon. Thus, fluid which might adhere and follow the exterior surface of the pipe 16 during a leak, is prevented from exiting from the first side edge 21 and second side edge 23 of the engaged body 14 half portions, and instead is directed back toward the central area 39 thereof such as shown in FIG. 10 where the fluid is centrally draining.

Such seals forming sealing members 26 may be formed of flexible polymers or plastics or the like which preferably are heat resistant, and may be adhered to the contact surface 20 of the device 10. Also, while not depicted in the black and white drawings herein, the contact side surface 20 of the device 10 may be colorized differently than the opposite exterior surface 11 such that users are given a visible cue to use the contact side surface 20 against the pipe 16 surface.

In FIG. 6 is shown another mode of the device 10 as in FIG. 1 but which depicts a plurality of channeling components including channeling projections 28 positioned on the contact side surface 20 of the body 12 of the device 10. Also shown are sealing members 26 as described above which are positioned in the central section 14.

The channeling projections 28 are preferably formed of polymeric or synthetic material which is resistant to hydrocarbon exposure such as neoprene or other materials and to high temperature water. Formed in elongated strips, the channeling projections 28 may be sewn or adhered or sonic welded or otherwise attached to the contact side surface 20 of the body 12. As shown, the parallel positioned channeling projections 28 form fluid channels 30 to urge fluid flowing from a leaking pipe downward toward the opposing first ends 29 and second ends 31 of the half sections of the engaged body 12. Containers such as buckets or other fluid catching devices may be positioned below the body 12 in the engaged position on a pipe 16 to catch the channeled fluid stream.

In FIG. 7 is depicted chemical reactive sections 34 which are engaged to the body 12 of the device 10 herein and can be employed in all modes disclosed. The reactive sections 34 will change appearance when the liquid encountered by the device 10 is hazardous such as where hydrocarbon fuel is leaking. The reactive sections 34 will contain areas or patches which chemically react and change color or appearance to warn the user of hydrocarbons or other detectable hazardous liquids, such as those manufactured by CTL Scientific Supply of Deer Park, N.Y.

In FIG. 8 is depicted the device 10 herein showing the body 12 from the exterior surface 11 side, and which is configured in a similar fashion to those of FIGS. 1-7 by inclusion of weighted first and second ends 29 and 31. Also shown are a plurality of flexible securement members 15. These securement members 15 are engaged to the body 12 at respective first ends and extend from both the first side edge 21 and second side edge 23, to distal ends of each securement member 15.

As shown in FIGS. 8-9, a first portion of separable fastener 19 is positioned upon a first side surface 25 of each securement member 15, adjacent a distal end of each of the flexible securement members 15. This first portion of the separable fasteners 19 located on the first side surface 25 will removably engage with the mating separable fasteners 17 positioned on opposite ends of the securement member 15 or on the body 12 adjacent thereto, to hold them connected to the body for storage as in FIG. 9.

On a second side surface 27 of each of the flexible securement members 15 as shown in FIG. 9, is also located first portions of separable fastener 19. These are removably engageable to second separable fastener 17 portions positioned on the exterior surface 11 of the body 12, to hold the body 12 in the engaged or as-used positioning shown in FIGS. 10 and 11.

Shown in FIG. 10 is the device 10 herein, having the body 12 in the engaged or as-used positioning upon a pipe 16 to contain and redirect fluid flow from the pipe 16 downward between draped half sections of the body 12. In this as-used positioning, the central section 14 of the contact side surface 20 is in operative contact with the top exterior surface and sides of the exterior surface of the pipe 16.

For all modes of the body 12 of the device 10 herein, in this engaged or as-used positioning of the device 10, shown in FIG. 11, a first half portion 35 of the body 12 hangs from one side of the pipe 16 and a second half portion 36 of the body 12 hangs from the opposite side of the pipe 16. One or multiple flexible securement members 15, are engaged to hold the first half portion 36 adjacent to the second half portion 36 of the body 12. A gap 38 formed between the first half portion 35 and second half portion 36, defines a channel for liquid to drain therebetween, The gap 38 is adjustable for size by tightening or loosening the connection of the securement members 15 which is accomplished by repositioning the first portion of separable fastener 19 in its engagement with the second portion of separable fastener 17.

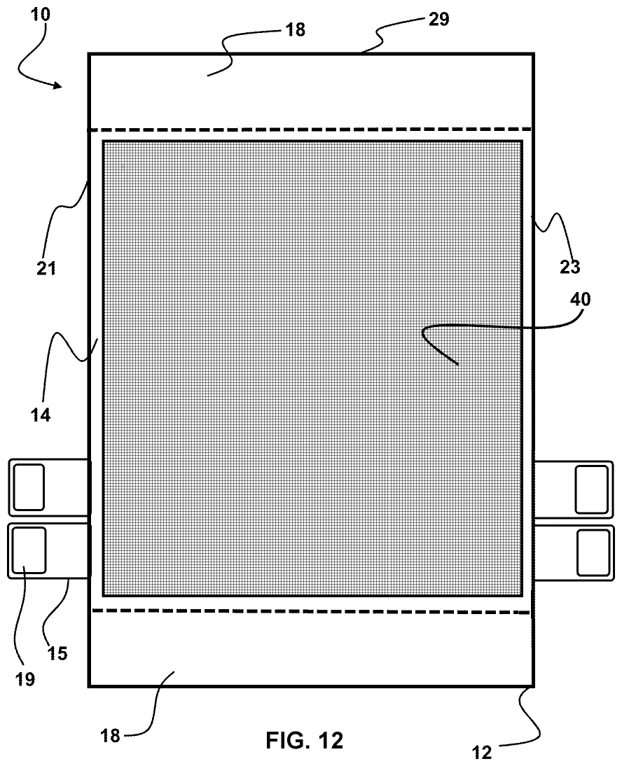

As shown in FIG. 12, all modes of the body 12 of the device 10 herein, may include a contacting layer 40 positioned upon the contact side surface 20 at least in the central section 14. By contacting layer is meant, that such a layer is formed of heat resistant and fluid impermeable material such as silicone which resists 550 degrees Fahrenheit and will not pass fluid, or neoprene which resists substantially 500 degrees and will not pass fluid therethough, or other plastic or polymeric materials which will not pass fluid therethrough, and which have heat resistance and will not melt or deform at high temperatures above 300 degrees. A contacting layer 40 which is fluid impervious and formed of polymeric or plastic or other material with a heat resistance above 450 degrees Fahrenheit is preferred for ships where super heated steam can reach temperatures between 400-475 degrees Fahrenheit.

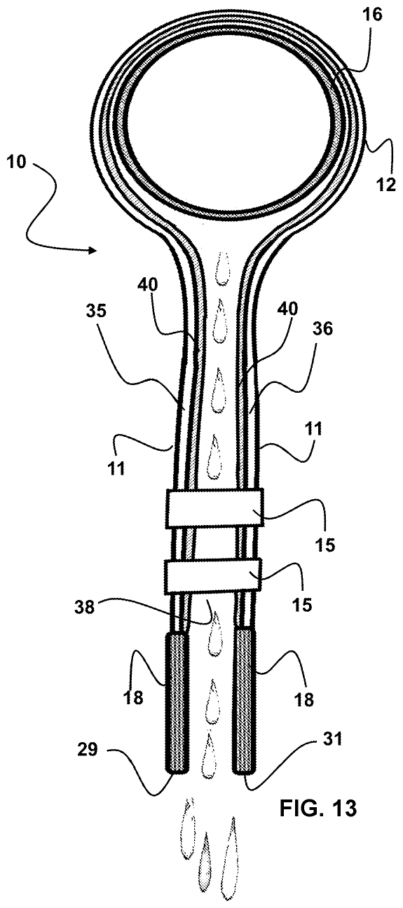

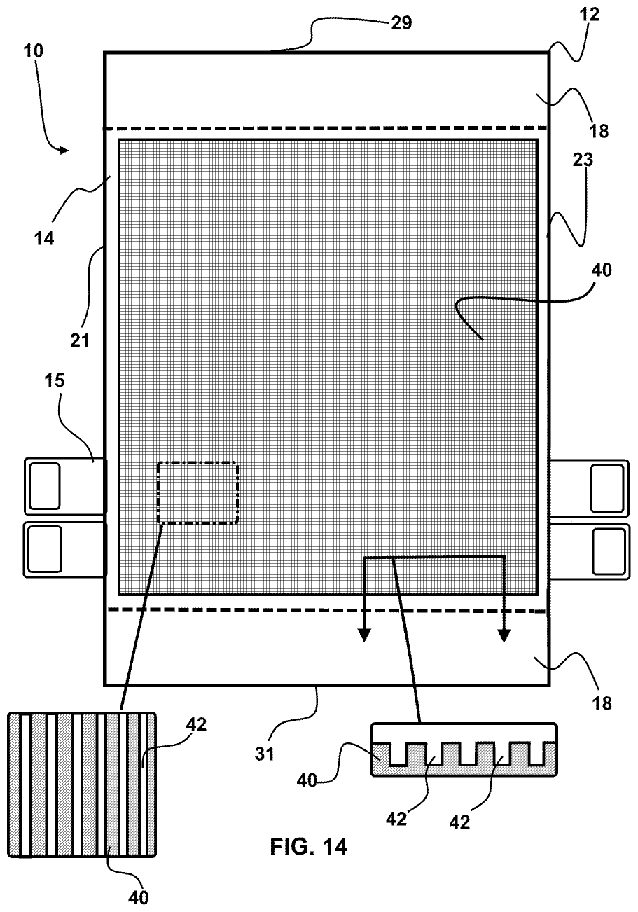

Shown in FIG. 13 is a side or sectional view of the device 10 herein, in the as-used or engaged position on a pipe 16, where the body 12 includes such a contacting layer 40 as in FIGS. 12 and 14. As can be seen, where the contacting layer 40 covers substantially all of the contact side surface 20, the body 12 is protected from fluid permeating or flowing through the contacting layer 40 as well as from damage from any high temperatures that the fluid might have upon leaking from a pipe 16. The as-used or engaged position of the device 10 which such a contacting layer 40, is shown for example in FIG. 13.

In FIG. 14, is shown an especially preferred mode of the device 10 as in FIGS. 12-13, wherein linear channels 42 are formed into the heat and fluid resisting contacting layer 40. These channels 42 run in lines running between the first end 29 and second end 31 of the body 12 and substantially normal or perpendicular thereto. With the body 12 of the device 10 in the as-used or engaged position of FIG. 13, these channels form pathways for fluid to follow from the pipe 16 and down the gap 38 between the two half sections 35 and 36 of the body 12. It was found in experimentation, that because the surface of the contacting layer 40 on opposing sides of each channel 42 forms a seal against the exterior surface of the pipe 16, that fluid exhausting from the pipe 16 will fill the pathways formed by the channels 42 and drain downward through them. This works especially well to prevent fluid from the first side edge 21 and second side edge 23 of the body 12 contacting the pipe 16, and significantly enhances the downward flow to collection containers.

Although not shown, the channels 42 depending into the contacting layer 40 may also be formed at angles running on each half portion 35 and 36 of the body 12. The channels 42 would run along angled lines running respectively, from the first side edge 21 of each half portion 35 and 36, toward a center area of the first end 29 and a center area of the second end 31.

Thus channels 42 will form fluid flows on the contacting layer 40 on both facing half portions and running through the gap 38, which are directed toward the center of the body 12 in the as-used position. Thus fluid exiting the gap 38 will be urged to exit at a center area such as in FIG. 10, between the first side edge 21 and second side edge 23, making it easier to capture it in containers.

It should be noted that any of the different depicted and described configurations and components of the fluid containment covering herein, can be employed with any other configuration or component shown and described as part of the device herein. Additionally, while the present invention has been described herein with reference to particular embodiments thereof and/or steps in the method of production or use, a latitude of modifications, various changes and substitutions are intended in the foregoing disclosure, and it will be appreciated that in some instance some features, or configurations, of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. A flexible fluid containment covering apparatus, configured for engagement over a leak in a pipe carrying fluid, comprising:
a flexible planar body, said body having a first side edge running opposite a second side edge;
said body having a first end extending between said first side edge and said second side edge;
said body having a second end extending between said first side edge and said second side edge;
said body having an exterior surface and having a contact side surface opposite said exterior surface;
said body positionable to an engaged position upon a leaking pipe;
said body in said engaged position having a center portion of said contact side surface forming a contact against an exterior surface of said pipe;
said body in said engaged position having a first half portion of said body hanging from a first side of said pipe, said first half portion extending to said first end;
said body in said engaged position having a second half portion of said body hanging from a second side of said pipe, said second half portion extending to said second end; and
a gap formed between said first half portion and said second half portion, said gap defining a fluid passage extending from said pipe to an exit between said first end and said second end; whereby fluid leaking from said pipe is channeled to said exit.

2. The flexible fluid containment covering apparatus of claim 1, additionally comprising:
said flexible body being formed of material which is heat resistant to temperatures of at least 300 degrees Fahrenheit.

3. The flexible fluid containment covering apparatus of claim 1, additionally comprising:
first weights engaged with said first end of said body; and secondary weights engaged with said second end of said body.

4. The flexible fluid containment covering apparatus of claim 2, additionally comprising:
first weights engaged with said first end of said body; and secondary weights engaged with said second end of said body.

5. The flexible fluid containment covering apparatus of claim 1, additionally comprising:
channeling members positioned upon said contact surface of said body; and
said channeling members running in a diagonal and directing said fluid toward a central area of said exit from said gap.

6. The flexible fluid containment covering apparatus of claim 2, additionally comprising:
channeling members positioned upon said contact surface of said body; and
said channeling members running in a diagonal and directing said fluid toward a central area of said exit from said gap.

7. The flexible fluid containment covering apparatus of claim 3, additionally comprising:
channeling members positioned upon said contact surface of said body; and
said channeling members running in a diagonal and directing said fluid toward a central area of said exit from said gap.

8. The flexible fluid containment covering apparatus of claim 4, additionally comprising:
channeling members positioned upon said contact surface of said body; and
said channeling members running in a diagonal and directing said fluid toward a central area of said exit from said gap.

9. The flexible fluid containment covering apparatus of claim 1, additionally comprising:
a contacting layer positioned upon said contact side surface of said body;
Said contacting layer having a contact surface forming said contact against an exterior surface of said pipe;
said contacting layer having a plurality of channels formed therein;
said channels extending along said first half portion of said body in lines running between said contact with said pipe and said first end of said body;
said channels extending along said second half portion of said body in lines running between said contact with said pipe and said second end of said body; and
said channels defining fluid pathways which direct fluid therethrough to said first and said second end of said body while in said engaged position.

10. The flexible fluid containment covering apparatus of claim 2, additionally comprising:
a contacting layer positioned upon said contact side surface of said body;
said contacting layer having a contact surface forming said contact against an exterior surface of said pipe;
said contacting layer having a plurality of channels formed therein;
said channels extending along said first half portion of said body in lines running between said contact with said pipe and said first end of said body;
said channels extending along said second half portion of said body in lines running between said contact with said pipe and said second end of said body; and
said channels defining fluid pathways which direct fluid therethrough to said first and said second end of said body while in said engaged position.

11. The flexible fluid containment covering apparatus of claim 3, additionally comprising:
a contacting layer positioned upon said contact side surface of said body;
Said contacting layer having a contact surface forming said contact against an exterior surface of said pipe;
said contacting layer having a plurality of channels formed therein;
said channels extending along said first half portion of said body in lines running between said contact with said pipe and said first end of said body;
said channels extending along said second half portion of said body in lines running between said contact with said pipe and said second end of said body; and
said channels defining fluid pathways which direct fluid therethrough to said first and said second end of said body while in said engaged position.

12. The flexible fluid containment covering apparatus of claim 4, additionally comprising:
a contacting layer positioned upon said contact side surface of said body;
Said contacting layer having a contact surface forming said contact against an exterior surface of said pipe;
said contacting layer having a plurality of channels formed therein;
said channels extending along said first half portion of said body in lines running between said contact with said pipe and said first end of said body;
said channels extending along said second half portion of said body in lines running between said contact with said pipe and said second end of said body; and
said channels defining fluid pathways which direct fluid therethrough to said first and said second end of said body while in said engaged position.

13. The flexible fluid containment covering apparatus of claim 9, additionally comprising:
said containing layer formed of heat resistant material which maintains structural integrity at a minimum temperature of at least 500 degrees Fahrenheit.

14. The flexible fluid containment covering apparatus of claim 1, additionally comprising:
a reactive section positioned upon said body, said reactive section changing color upon a contact of said body with hydrocarbons.

15. The flexible fluid containment covering apparatus of claim 8, additionally comprising:
a reactive section positioned upon said body, said reactive section changing color upon a contact of said body with hydrocarbons.

16. The flexible fluid containment covering apparatus of claim 9, additionally comprising:
a reactive section positioned upon said body, said reactive section changing color upon a contact of said body with hydrocarbons.
